(19) United States
(12) Patent Application Publication
(10) Pub. No.: US 2023/0333220 A1
(43) Pub. Date: Oct. 19, 2023

(54) SYSTEMS AND METHODS FOR OPERATING LIDAR SYSTEMS

(71) Applicant: SHENZHEN ADAPS PHOTONICS TECHNOLOGY CO., LTD., Shenzhen (CN)

(72) Inventors: Chao ZHANG, Shenzhen (CN); Kai Zang, Shenzhen (CN); Zhijie Ma, Shenzhen (CN)

(21) Appl. No.: 18/341,462

(22) Filed: Jun. 26, 2023

Related U.S. Application Data
(63) Continuation of application No. PCT/CN2021/136081, filed on Dec. 7, 2021.

(30) Foreign Application Priority Data
Dec. 30, 2020 (CN) 202011631135.X

(51) Int. Cl. G01S 7/4865; G01S 7/48; G01S 7/4863; G01S 17/10

(52) U.S. Cl. CPC G01S 7/4865; G01S 7/4808; G01S 7/4863; G01S 17/10

(57) ABSTRACT

The present invention is direct to lidar systems and methods. According to an embodiment, the present invention provides a lidar system that comprises a laser source, an optical module, a pixel circuit with an array of single photon avalanche diodes (SPADs), a logic circuit, a time-to-digital converter (TDC). The laser source emits a pulsed laser, and the optical module receives the reflected laser signal. The pixel circuit, positioned behind the optical module, generates electrical outputs based on the reflected laser signal. The logic circuit activates and deactivates SPADs at different times, depending on their distances from the laser source. The TDC creates histogram data from the SPAD array, with each histogram data comprising multiple intensity values for different time bins. There are other embodiments as well.

### CROSS-REFERENCES TO RELATED APPLICATIONS

The present application is a continuation application to PCT Application No. PCT/CN2021/136081, filed Dec. 7, 2021, which claims priority to Chinese Application No. 202011631135.X, filed Dec. 30, 2020, both of which are common own and incorporated by reference herein for all purposes.

### BACKGROUND OF THE INVENTION

Time of Flight (ToF) technology is a technique with many applications, where probing light is emitted from a transmitter, bounced off a target object, and then detected by a receiver. The propagation time of the probing light, from emission to reception, is used to calculate the spatial distance between the object and the sensor. Existing ToF-based ranging systems typically determine the ToF by creating a histogram of the sensed signals, which is subsequently stored in the system's memory.

Unfortunately, existing approaches are inadequate for reasons explained below. New and improved systems and methods are desired.

### BRIEF SUMMARY OF THE INVENTION

The present invention is direct to lidar systems and methods. According to an embodiment, the present invention provides a lidar system that comprises a laser source, an optical module, a pixel circuit with an array of single photon avalanche diodes (SPADs), a logic circuit, a time-to-digital converter (TDC). The laser source emits a pulsed laser, and the optical module receives the reflected laser signal. The pixel circuit, positioned behind the optical module, generates electrical outputs based on the reflected laser signal. The logic circuit activates and deactivates SPADs at different times, depending on their distances from the laser source. The TDC creates histogram data from the SPAD array, with each histogram data comprising multiple intensity values for different time bins. There are other embodiments as well.

According to an embodiment, the present invention provides a lidar system that includes a housing, a laser source, an optical module, a pixel circuit, a logic circuit, a time-to-digital converter (TDC), and a memory device. Within the housing, the laser source is positioned at a first location and is configured to generate a pulsed laser during a first time. The optical module, placed at a second location within the housing, is configured to receive a reflected laser signal. The pixel circuit, positioned at a third location within the housing and behind the optical module, generates electrical outputs based on the reflected laser signal. It comprises an array of single photon avalanche diodes (SPADs), specifically a first SPAD and a second SPAD, which are positioned at different distances from the first location. The logic circuit, coupled to the pixel circuit, activates the first SPAD and deactivates the second SPAD during a second time. The TDC generates histogram data corresponding to the array of SPADs, with each data set comprising n intensity values corresponding to n time bins. The generated histogram data are stored in the memory device.

In some implementations, the logic circuit also activates the second SPAD and deactivates the first SPAD during a third time. The first and second SPADs can be activated during overlapping time intervals. Further, the histogram data may include a first histogram associated with the first SPAD and a second histogram associated with the second SPAD, with the first histogram being updated during the second time. An embodiment associates the second and third times with different proximities between the second SPAD and the first location. Further embodiments include a processor that calculates a target distance using at least a difference between the first time and the second time, and a quenching circuit coupled to the pixel circuit and the logic circuit to reset the second SPAD during the second time. The logic circuit can be configured to activate SPADs based on their proximities to the first location, and the array of SPADs can comprise various detection zones with different SPADs positioned in them. The logic circuit can be further configured to sequentially activate these detection zones.

According to another embodiment, the present invention provides a method of operating a lidar system, which involves generating a pulsed laser during a first time from a laser source positioned at a first location within a housing. The optical module, positioned at a second location within the housing, receives the reflected laser signal. The pixel circuit, located at a third location within the housing and behind the optical module, then generates electrical outputs based on the reflected laser signal. The pixel circuit includes an array of single photon avalanche diodes (SPADs), which are positioned at different distances from the first location, with at least a first SPAD and a second SPAD. The method involves a logic circuit coupled to the pixel circuit that activates the first SPAD and deactivates the second SPAD during a second time. The time-to-digital converter (TDC) then generates histogram data corresponding to the array of SPADs, with each data set comprising n intensity values corresponding to n time bins. The histogram data is then stored in a memory device.

Additional steps in this method may be performed in various embodiments. These include activating the second SPAD and deactivating the first SPAD during a third time by the logic circuit, as well as activating the first SPAD and the second SPAD during an overlapping time interval. The second time and the third time may be associated with different proximities between the second SPAD and the first location. The method can also include a step wherein a processor calculates a target distance using at least the difference between the first time and the second time. Lastly, in another embodiment, a quenching circuit coupled to the pixel circuit and the logic circuit is used to reset the second SPAD during the second time.

According to another embodiments, the present invention provides a laser emitter stationed at a first location, programmed to emit a pulsed laser during a specific first time. A sensor module, configured to receive a reflected laser signal, is positioned at a second location. This sensor module contains an array of single photon avalanche diodes (SPADs), each positioned at varying distances from the laser emitter. A logic circuit, connected to the sensor module, has the capacity to selectively activate SPADs during different times based on their relative distances from the first location. A quenching circuit, coupled to the sensor module and the logic circuit, is designed to reset the activated SPADs during those specific times. The system also includes a time-to-digital converter (TDC) that creates histogram data corresponding to the activated SPADs. This histogram data is stored in a memory device for future use. A processor is integrated into the system to analyze the stored histogram data, enabling the determination of the distance to a target object.

It is to be appreciated that embodiments of the present invention provide many advantages over conventional techniques. In various embodiments, selective activation of SPADs, based on their proximity to the laser source and the incidence of parallax, can improve object recognition. This selective activation strategy accounts for parallax effects, which occur due to differences in apparent position of an object viewed along two different lines of sight. By activating SPADs at different distances from the laser source at different times, the system can more accurately discern the position and structure of objects, leading to enhanced object recognition capabilities. It is to be appreciated that selective activation and subsequent distance calculation take into account the parallax effect, thereby providing precise depth measurement. This strategy is helpful for applications like 3D imaging and mapping, where the accurate capture of the depth dimension is crucial. In various implementations, selective activation of SPADs allows the lidar system to better calculate distances to multiple targets at various ranges, providing a higher accuracy of depth perception. This is helpful in applications like autonomous vehicles, robotics, and 3D mapping, where accurate depth and distance information is critical for safe and efficient operation. As only a subset of SPADs is activated at any given time, this approach can lead to substantial energy savings. It reduces power consumption, which can be particularly beneficial for battery-powered devices. The use of time-to-digital converters (TDC) in generating histogram data corresponding to activated SPADs allows the system to produce high-quality, granular data on detected objects, improving overall system performance.

Embodiments of the present invention can be implemented in conjunction with existing systems and processes. For example, a lidar system with selectively activated SPADs according to the present invention can be used in a wide variety of systems, including autonomous vehicles, surveillance systems, mapping applications, robotics, and drones. Additionally, various techniques according to the present invention can be adopted into existing systems via hardware modifications and software updates, or through integration into sensor fusion systems where lidar data is used in conjunction with data from other sensor types. There are other benefits as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a schematic diagram illustrating the laser beams reflected from target objects at different distances and their illumination positions on the receiving end.

FIG. 2a depicts the positions of laser beams reflected from target objects at different distances on the receiving end, while FIG. 2b shows the time-line numbering curve of the laser beams reflected from target objects at different distances.

FIG. 3 is a flow diagram illustrating a flight time-based addressing method provided in this application.

FIG. 4 is a schematic diagram showing the scattered illumination on the sensing module according to an embodiment.

FIG. 5 is a histogram of partially overlapping time periods in the time domain for an embodiment.

FIG. 6 is a histogram of an embodiment where triggering control is performed together for two rows of single-photon avalanche diodes (SPADs) corresponding to time periods.

FIG. 7a is a schematic diagram showing the formation of light spots by two target objects on the sensing module in one embodiment, and FIG. 7b is the corresponding histogram of FIG. 7a.

FIG. 8 is a schematic diagram illustrating the structural configuration of a ranging system in one embodiment.

FIG. 9 is a schematic diagram illustrating the circuit structure of a logic circuit in one embodiment.

### DETAILED DESCRIPTION OF THE INVENTION

The present invention is direct to lidar systems and methods. According to an embodiment, the present invention provides a lidar system that comprises a laser source, an optical module, a pixel circuit with an array of single photon avalanche diodes (SPADs), a logic circuit, a time-to-digital converter (TDC). The laser source emits a pulsed laser, and the optical module receives the reflected laser signal. The pixel circuit, positioned behind the optical module, generates electrical outputs based on the reflected laser signal. The logic circuit activates and deactivates SPADs at different times, depending on their distances from the laser source. The TDC creates histogram data from the SPAD array, with each histogram data comprising multiple intensity values for different time bins. There are other embodiments as well.

Despite the efficacy of ToF-based ranging systems, there are a few areas in which these systems could be improved. The primary issue involves the high data volume associated with the histogram, which results in significant memory usage. This is a crucial concern for industry applications, where optimal memory usage is highly desirable. Additionally, current systems struggle with multi-target detection, due to their reliance on determining scatter points' positions for distance calculation of the targets.

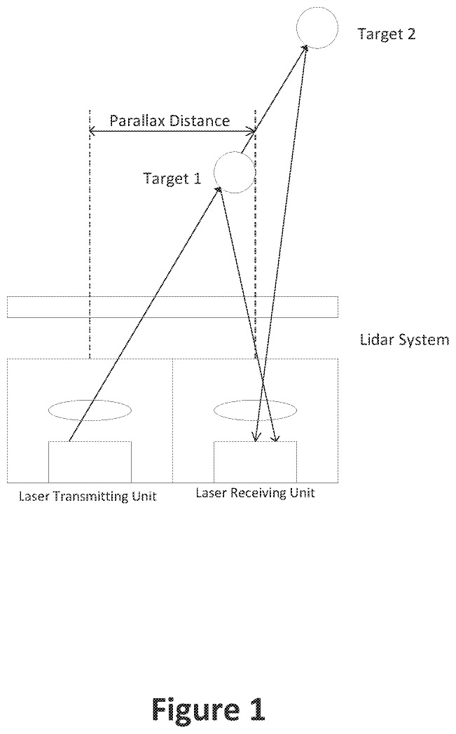

As an example, consider a Time of Flight (ToF) scattering scenario commonly encountered in a lidar system. As an example, a lidar system includes a laser transmitting unit and a laser receiving unit. The operation of the system begins when a laser beam is emitted from the transmitting unit. This laser beam interacts with target objects which are positioned at different distances from the lidar system. Upon interacting with the targets, the laser beam is reflected back towards the lidar system. A unique phenomenon, enabled by the principle of parallax, occurs during this interaction. Despite the reflection signals originating from the same laser beam, when these signals are reflected from different distances (such as from a first and a second target), they are projected onto different pixels on the image sensor. This is visually represented in FIG. 1.

The fixed separation between the laser transmitting end and the laser receiving end, known as the baseline distance, plays a critical role in this system. This baseline distance aids in the calculation of the imaging coordinates of the target objects at varied distances at the receiving end or sensor. By measuring the time taken for the laser beam to travel to each target and return, the system calculates the distance to each target. The differentiation in projection onto the sensor due to parallax allows for distinction between objects at different distances. This methodology, coupled with the baseline distance, enables the system to accurately determine the imaging coordinates of target objects at varying distances. Through the effective use of parallax and the ToF principle, this advanced lidar system offers improved imaging and precise distance calculation capabilities, marking a significant advancement in lidar technology.

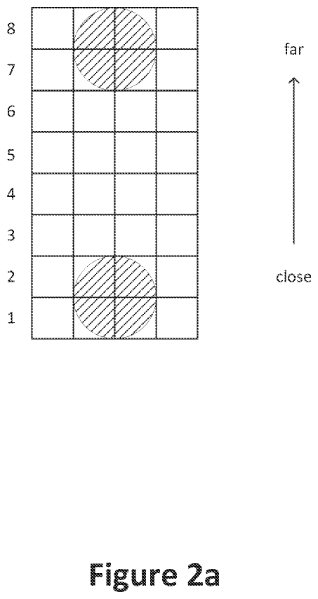

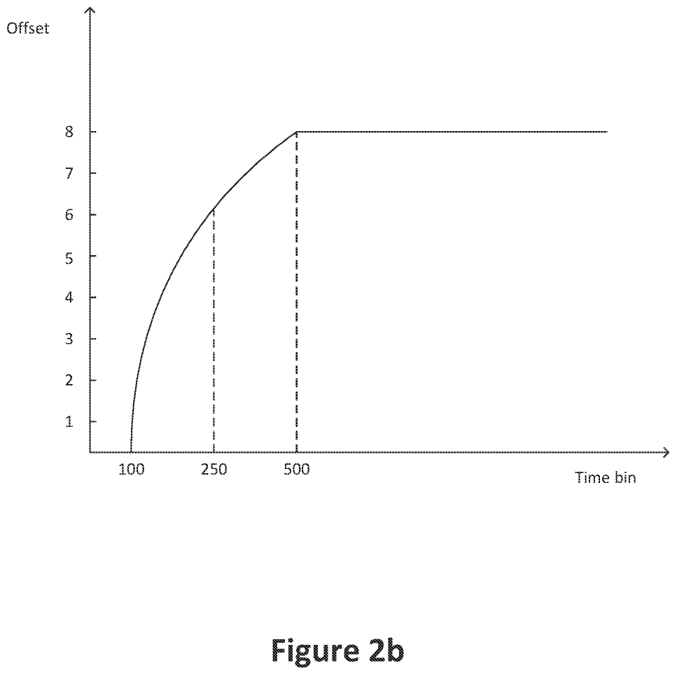

FIG. 2a provides a schematic representation of the positions of laser beams that are reflected by target objects at different distances and received at the sensor. The numbers 1-8 denote the row numbers of pixels, specifically the single-photon avalanche diodes (SPADs).

Given that the distance to a target object is proportionate to the flight time, it is feasible to derive a time-row number curve as illustrated in FIG. 2b. It becomes evident that when the distance of the target object exceeds a particular range from the sensor, the coordinates of the scattered points tend to remain stable.

Therefore, by mapping the distance of the target object with the imaging coordinates of the sensor, we are capable of selectively capturing triggering events from different SPADs within the corresponding time periods. These collected events can then be combined to form a comprehensive histogram, offering a more efficient method of data acquisition and processing in the ToF-based ranging systems.

The present invention proposes a novel methodology and system designed to reduce data volume associated with histogram storage, thereby improving overall memory efficiency. Simultaneously, the invention provides a mechanism to achieve multi-target detection, circumventing the need for scatter points' position determination in calculating target distances. In doing so, it sets a new precedent in the field of electromagnetic wave ranging, offering improved performance and enhanced capabilities.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

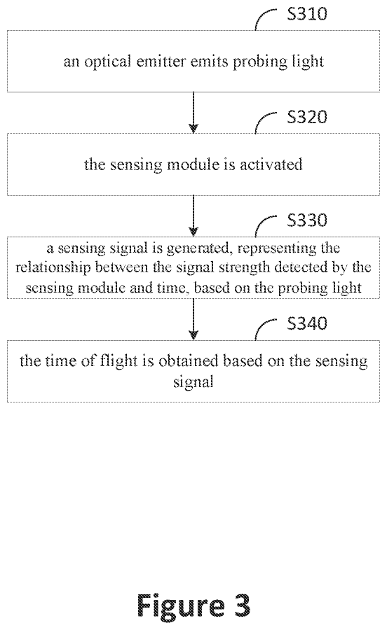

According to various embodiments, the present invention provides a time-of-flight-based addressing method as shown in FIG. 3, which includes:

S310: an optical emitter, which may be a light source like a pulsed laser, emits probing light. It should be noted that the term “light” in this application refers to any form of optical radiation, encompassing radiation in the visible, infrared, and ultraviolet ranges.

S320: the sensing module, configured to receive the reflected probing light from the target object, is activated. For instance, one or more beams of light from pulsed laser sources are directed towards the target object or field of view, thereby forming an illumination spot. The sensing module then receives and detects the reflected probing light. In an embodiment, the sensing module comprises a Single-Photon Avalanche Diode (SPAD) array. Each SPAD may also include associated bias and control circuitry elements, such as a quench circuit connected to the SPAD. SPADs, also referred to as Geiger-mode Avalanche Photodiodes (GAPD), are detectors designed to capture single photons with a high time resolution, on the order of tens of picoseconds, and can be manufactured using dedicated semiconductor or standard CMOS processes. A single SPAD functions as a 1-bit high-speed Analog-to-Digital Converter (ADC) that directly produces a digital signal using a simple inverter, outputting “0” when there is no signal, and “1” when there is a signal.

S330: a sensing signal is generated, representing the relationship between the signal strength detected by the sensing module and time, based on the probing light. The sensing signal is created considering the correlation between the various sensing areas of the sensing module and time periods. For example, only the signal strength detected by the corresponding sensing area in each time period is represented in the sensing signal. More precisely, the sensing signal is produced by accumulating the signal strengths detected by the sensing module's various sensing areas corresponding to the time periods, which are associated with the system's design. Refer to FIGS. 1, 2a, and 2b for further clarification. Within a certain time range, the closer the sensing area of the sensing module is to the optical emitter, the longer the corresponding time period from the start of the probing light emission. Nonetheless, when the target object exceeds a certain distance from the sensor, the coordinates of the scattered points become virtually fixed. Based on the baseline distance between the optical emitter and the sensing module, the relationship between the distance to the target object and the imaging coordinates of the sensing module can be precalculated. Consequently, the corresponding relationship between each sensing area and time period of the sensing module can be obtained and stored in a data table for subsequent recall during ToF addressing.

S340: the time of flight is obtained based on the sensing signal. In an embodiment, the time of flight is determined by constructing a histogram corresponding to the sensing signal. Specifically, a histogram can be formed based on time bins and the respective light signal intensities of each time bin. The peak on the histogram signifies the time of flight corresponding to the target object. The distance to the target object can be calculated based on the time of flight, thus concluding the ranging process. That is, for a given flight time, t, the flight distance, s, of the probing light can be determined as s=ct, where c denotes the speed of light.

The aforementioned Time-of-Flight (ToF) based addressing method utilizes the concept that within a certain range, the more distant the target object from the light emitter, the closer the position of the reflected detection light on the sensing module is to the light emitter. By integrating this principle with the system design, the corresponding relationship between each sensing zone of the sensing module and the time period can be established (as the time period also represents the distance between the target object and the light emitter). Therefore, only the detected light signals from the respective sensing zones are incorporated into the sensing signal for each time period. This method efficiently reduces power consumption and conserves data storage space, hence reducing the memory footprint.

In an embodiment, the sensing module is partitioned into strip-shaped regions, forming various sensing zones. Alternatively, the sensing zones may assume other shapes, such as block-shaped regions, in other embodiments.

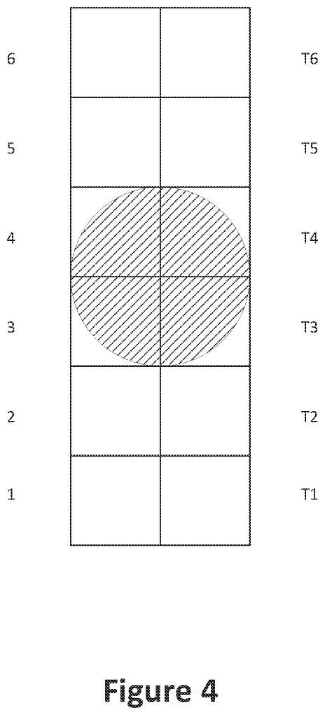

The specifics of the ToF-based addressing method are further elucidated through distinct examples. In the instance demonstrated in FIG. 4, the maximum movement range of the scattered points is represented by a 6×2 SPAD configuration, with each scattered point occupying a 2×2 SPAD area in the 3rd and 4th rows. Based on the correlation between the distance of the target object and the imaging coordinates of the sensing module, each row of SPADs corresponds to time periods T1-T6. For instance, only photons within T1 are integrated into the histogram during the triggering event of the first row of SPADs, and only photons within T2 are added to the histogram during the triggering event of the second row of SPADs, and so forth. The final histogram is compiled by accumulating the sensing signals from each time period. By examining the histogram, the specific SPAD where the scattered point falls and the distance to the target object can be determined, without the necessity of pre-measuring the precise coordinates of the scattered points via emitting clustered laser pulses.

In an embodiment, the rows of the SPAD array are oriented perpendicular to the line connecting the sensing module and the light emitter. This means that the direction of the line connecting the first SPAD to the last SPAD in each row runs perpendicular to the direction of the line linking the sensing module and the light emitter. Consequently, the distance between the SPADs and the light emitter within the same row tends to be consistent.

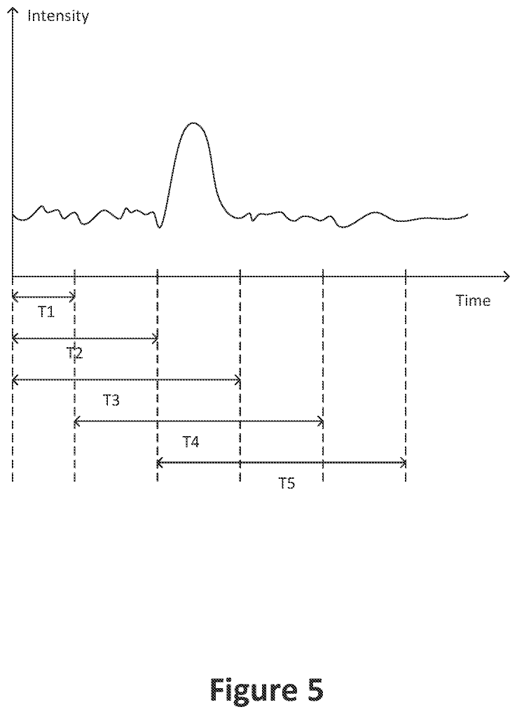

In an embodiment, the time periods may partially overlap in the temporal domain, as depicted in FIG. 5.

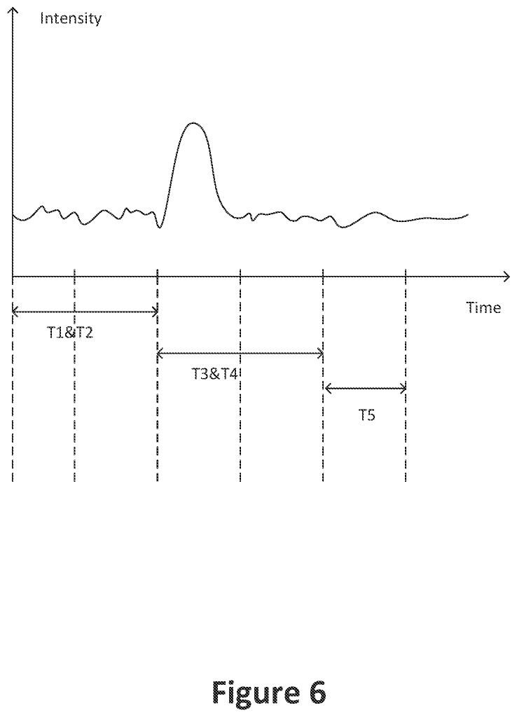

As an example, if a sensing module divides into more time intervals, the chip implementation becomes more complex. In an embodiment, two or more rows of SPADs can be combined to reduce the number of time intervals. For example, two rows of SPADs can correspond to one time interval, thereby simplifying the chip. In another embodiment, two or more time intervals can be controlled for triggering together, as shown in FIG. 6. In embodiment shown in FIG. 6, T1&T2 and T3&T4 do not overlap. In other embodiments, T1&T2 and T3&T4 can partially overlap (or other time intervals can partially overlap).

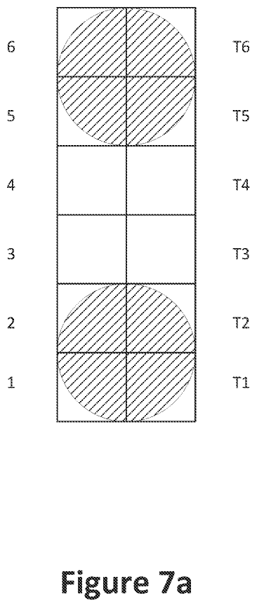

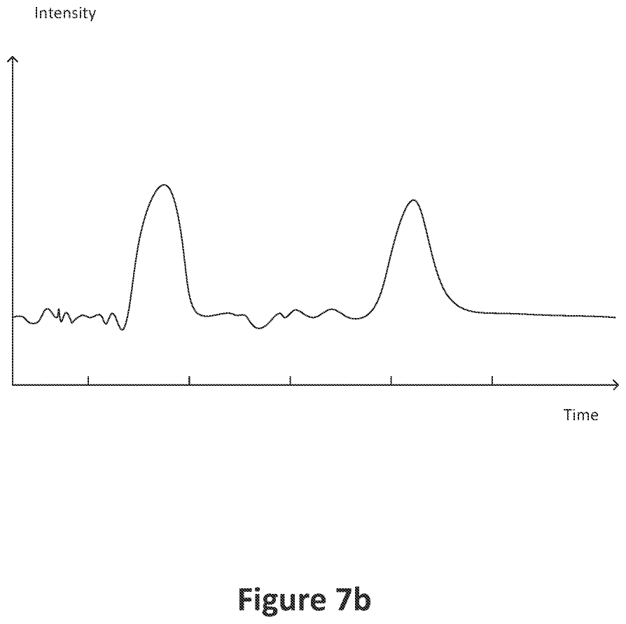

For example, the aforementioned time-of-flight-based addressing method provides an ability to detect multiple targets. FIG. 7a is a schematic diagram of two target objects forming light spots on the sensing module in one embodiment, and FIG. 7b is a histogram corresponding to FIG. 7a. It can be seen that multiple target objects at different distances naturally reflects on different SPADs. By selectively outputting the distance of all SPADs, information of the different target objects can be collected. Finally, by analyzing the histogram, the flight time of all target objects can be obtained, thereby measuring the depth of multiple targets.

Embodiments of the present invention provides a ranging system (e.g., a lidar system) that includes a light emitter 110, sensing module 210, quench circuit 220, controller 230, logic circuit 240, Time-to-Digital Converter (TDC) 250, and memory 260. The light emitter 110 is configured to emit detection light. The light emitter 110 can use a laser light source, such as a pulsed laser.

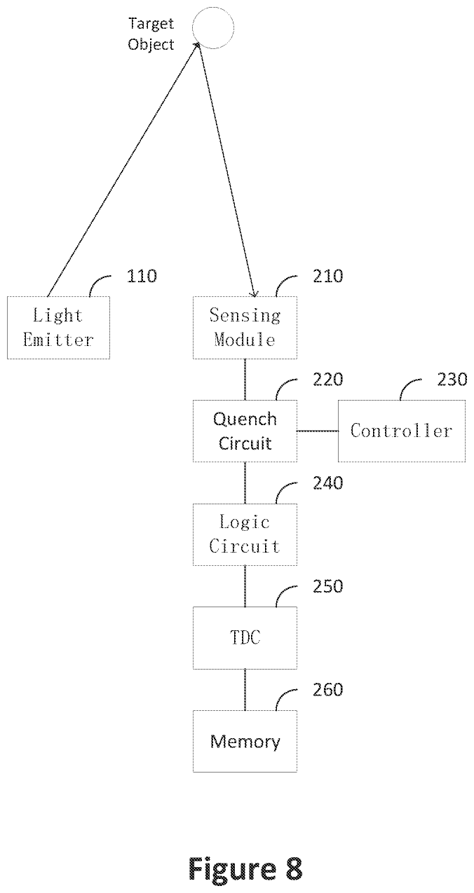

The sensing module 210 is configured to receive the detection light reflected by the target object. In one embodiment, the sensing module 210 includes an SPAD array. The sensing module 210 is divided into multiple sensing zones according to the distance from the light emitter 110. Each quenching circuit 220 connects to a sensing zone (only one quenching circuit 220 is shown in FIG. 8). The quenching circuit is used to reduce the reverse bias voltage of the SPAD and reset the SPAD to its initial state after an avalanche current occurs and is read out, entering a new round of detection state. The quenching circuit can adjust the pulse width of the SPAD output signal. In one embodiment, the quenching circuit 220 also includes a gate as a signal output switch of the connected sensing zone. The controller 230 is connected to each gate and controls each gate to only conduct in the time interval corresponding to the sensing zone based on the correspondence between each sensing zone and time interval. The corresponding relationship is that within the first time range, the closer the sensing zone of the sensing module 210 to the light emitter 110, the longer the corresponding time interval from the start time of the detection light emission (when the distance of the target object from the sensing module 210 exceeds a certain distance, the detection light is reflected by the target object on the coordinates of the sensing module 210 are almost fixed, so the corresponding relationship that the closer the sensing zone of the sensing module 210 to the light emitter 110, the longer the corresponding time interval from the start time of the detection light emission does not hold in the entire time domain).

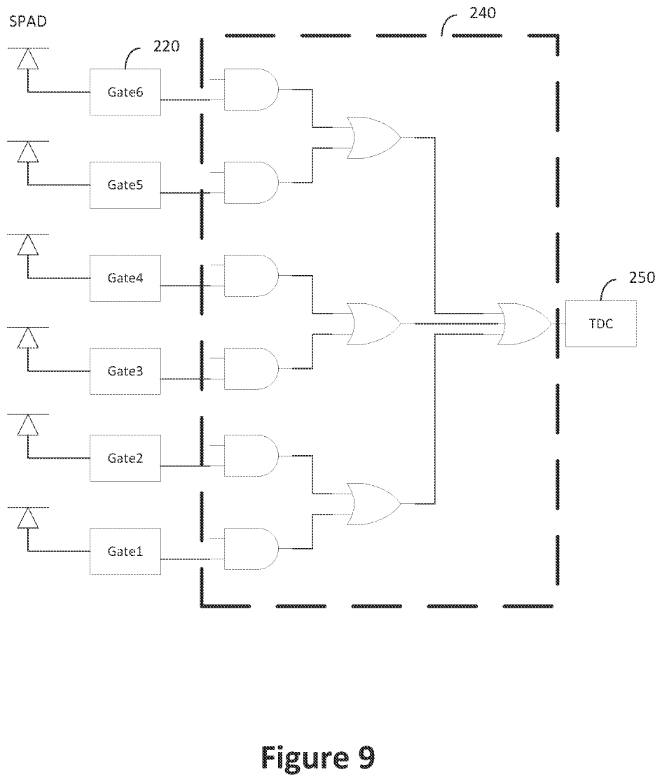

In certain embodiment, the SPAD selectively transmits signals, through a gating mechanism, to include only photons that match specific time intervals in the histogram. After proceeding through quenching circuits and other associated circuits, the SPAD links to a control circuit that selectively dispatches photons within the respective time intervals to a TDC 250, thereby precluding photons outside the time range from activating the TDC. The logic circuit 240 may incorporate multiple gate circuits, such as AND gates or OR gates. FIG. 9 illustrates an architecture of the logic circuit 240 in a specific embodiment, where each of the six exemplary SPADs connects to a respective gate. The logic circuit 240 comprises six AND gates, each linked to the output of a gate. Every two AND gates connect to an OR gate (each OR gate input linked to one of the two AND gates), and three OR gates connect to a three-input OR gate, whose output links to the TDC 250. The gate signals may align temporally (i.e., no temporal overlap between distinct gate signals) or partially overlap in the time domain.

In one embodiment, a memory unit 260 is utilized to store the histogram derived from the digital signals produced by the TDC 250. The controller 230 can extract the time-of-flight from the histogram and subsequently compute the distance to the target object.

In another embodiment, the sensing module 210 receives reflected detection light from multiple target objects, and the controller 230 establishes the flight time of the multiple target objects based on the digital signals emitted by the TDC 250.

The current application also proposes a ranging method. Following the acquisition of flight time according to any of the aforementioned embodiments of the time-of-flight-based addressing method, the distance between the target object and the light emitter is computed based on the flight time.

It is understood that while the steps in the flowchart of FIG. 3 are depicted sequentially following the direction of the arrows, they are not strictly required to be executed in the order indicated by the arrows. Unless explicitly stipulated in this document, there is no strict limitation to the sequence of these steps' execution. Some steps in FIG. 3 may encompass multiple sub-steps or stages, and these sub-steps or stages do not necessarily need to be carried out simultaneously; they may be performed at different times. The order of performing these steps or stages may not strictly follow a linear pattern but may interleave or alternate with parts of other steps or stages.

The current application additionally provides a computer-readable storage medium that stores a computer program. When executed by a processor, the computer program carries out the steps of the time-of-flight-based addressing method or ranging method as outlined in any of the previously mentioned embodiments.

The present application also offers a computer device, composed of a memory and a processor. The memory contains a computer program, and the processor executes the computer program to enact the steps of the time-of-flight-based addressing method or ranging method as depicted in any of the previously discussed embodiments.

Further, this application provides a computer program product that incorporates a computer program. When the computer program is executed by a processor, it facilitates the implementation of the steps of the time-of-flight-based addressing method or ranging method as outlined in any of the previously described embodiments.

In this field, average technical personnel can comprehend and execute all or part of the processes depicted in the above implementation examples. These processes can be guided and accomplished through computer programs that regulate the pertinent hardware. The computer program can be stored in a non-volatile, computer-readable storage medium. Upon the execution of the computer program, it can include the processes delineated in the aforementioned implementation examples.

In the context of this specification, terms such as “some embodiments,” “other embodiments,” “ideal embodiments,” and similar phrasing are intended to convey that the distinct features, structures, materials, or characteristics associated with these embodiments or instances are incorporated in at least one implementation or instance of the current invention. In this specification, the descriptive illustrations linked with the aforementioned terms do not necessarily denote the same embodiments or examples.

The diverse technical aspects of the aforementioned embodiments can be amalgamated in any arbitrary fashion. To maintain brevity, not every potential combination of the technical features in these embodiments has been detailed. Nevertheless, as long as the amalgamation of these technical aspects does not create contradictions, it should be considered within the boundaries of the current specification.

The aforementioned embodiments illustrate multiple implementation modes of the current invention, detailed in a more specific and thorough manner. This, however, does not denote limitations on the scope of the invention. It's worth noting that proficient technicians in this field can perform various modifications and enhancements without deviating from the conceptual framework of the present invention, and these modifications and enhancements should fall within the protective purview of the present invention. Therefore, the protective scope of the invention should be determined in accordance with the appended claims.

This diagram is merely an example, which should not unduly limit the scope of the claims. One of ordinary skill in the art would recognize many variations, alternatives, and modifications.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A lidar system comprising:
a housing;
a laser source configured to generate a pulsed laser during a first time, the laser source being positioned at a first location of the housing;
an optical module configured receiving a reflected laser signal, the optical module being positioned at a second location of the housing;
a pixel circuit configured to generate electrical outputs based on the reflected laser signal, the pixel circuit comprising an array of single photon avalanche diodes (SPADs), the pixel circuit being positioned at a third location of the housing and behind the optical module, the array of SPADs comprising a first SPAD and a second SPAD, the first SPAD and the second SPAD being positioned different distances from the first location;
a logic circuit coupled to the pixel circuit, the logic circuit being configured to activate the first SPAD and deactivate the second SPAD during a second time;
a time-to-digital converter (TDC) configured to generate histogram data corresponding to the array of SPADs, each of the histogram data comprising n intensity values corresponding to n time bins;
a memory device configured to store the histogram data.

2. The system of claim 1, wherein the logic circuit is further configured to activate the second SPAD and deactivate the first SPAD during a third time.

3. The system of claim 2, wherein the first SPAD and the second SPAD are activated during an overlapping time interval.

4. The system of claim 2, wherein the histogram data comprising a first histogram associated with the first SPAD and a second histogram associated with the second SPAD, the first histogram being updated during the second time.

5. The system of claim 2, wherein the second time is associated with a first proximity between the first SPAD and the first location, and the third time is associated with a second proximity between the second SPAD and the first location.

6. The system of claim 1, further comprising a processor configured to calculate a target distance using at least a difference between the first time and the second time.

7. The system of claim 1, further comprising a quenching circuit coupled to the pixel circuit and the logic circuit, the quenching circuit being configured to reset the second SPAD during the second time.

8. The system of claim 1, wherein the logic circuit is configured to activate SPADs based on SPAD proximities to the first location.

9. The system of claim 1, wherein the array of SPADs comprise a first detection zone and second detection zone, the first SPAD and a third SPAD being positioned in the first detection zone, the second SPAD and a fourth SPAD being positioned in the second detection zone.

10. The system of claim 9, wherein the logic circuit is configured to sequentially activate the first detection zone and the second detection zone.

11. The system of claim 9, wherein the logic circuit is configured to sequentially activate the first detection zone and a third detection zone, the first detection zone and the third detection zone being non-adjacent.

12. A method of operating a lidar system comprising:
generating a pulsed laser during a first time from a laser source positioned at a first location of a housing;
receiving a reflected laser signal at an optical module positioned at a second location of the housing;
generating electrical outputs based on the reflected laser signal at a pixel circuit, the pixel circuit comprising an array of single photon avalanche diodes (SPADs), the pixel circuit being positioned at a third location of the housing and behind the optical module, the array of SPADs comprising a first SPAD and a second SPAD positioned at different distances from the first location;
activating the first SPAD and deactivating the second SPAD during a second time by a logic circuit coupled to the pixel circuit;
generating histogram data corresponding to the array of SPADs, each of the histogram data comprising n intensity values corresponding to n time bins with a time-to-digital converter (TDC); and
storing the histogram data in a memory device.

13. The method of claim 12, further comprising activating the second SPAD and deactivating the first SPAD during a third time using the logic circuit.

14. The method of claim 13, further comprising activating the first SPAD and the second SPAD during an overlapping time interval.

15. The method of claim 13, wherein the second time is associated with a first proximity between the second SPAD and the first location, and the third time is associated with a second proximity between the second SPAD and the first location.

16. The method of claim 12, further comprising calculating a target distance using at least a difference between the first time and the second time by a processor.

17. The apparatus of claim 12, further comprising resetting the second SPAD during the second time with a quenching circuit coupled to the pixel circuit and the logic circuit.

18. A lidar system, comprising:
a laser emitter configured to emit a pulsed laser during a first time, the laser emitter being positioned at a first location;
a sensor module positioned at a second location, the sensor module being configured to receive a reflected laser signal and comprising an array of single photon avalanche diodes (SPADs), the array of SPADs comprising a plurality of SPADs positioned at different distances from the laser emitter;
a logic circuit coupled to the sensor module, configured to selectively activate SPADs during different times based on the relative distance of the SPADs from the first location;
a quenching circuit coupled to the sensor module and the logic circuit, the quenching circuit being configured to reset activated SPADs during the different times;
a time-to-digital converter (TDC) configured to generate histogram data corresponding to the activated SPADs in the array;
a memory device configured to store the generated histogram data; and
a processor configured to analyze the stored histogram data to determine distance of a target object.
